(19) United States
(12) Patent Application Publication
(10) Pub. No.: US 2005/0046747 A1
(43) Pub. Date: Mar. 3, 2005

(54) Display device, display system, and storage

(75) Inventors: Dong-sik Park, Suwon-si (KR); Han-sung You, Sungnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/926,149

(22) Filed: Aug. 26, 2004

(30) Foreign Application Priority Data
Aug. 28, 2003 (KR) 2003-59914

(51) Int. Cl. H04N 5/268

(52) U.S. Cl. 348/569; 348/706; 348/554

(57) ABSTRACT

A display device receiving image signals from an external device and displaying images, having a data storage storing a display device type identifying data including information about a type of the display device, the display device including a setup control part provided in the external device offering a plurality of user interfaces to set a display condition of the images corresponding to a plurality of display device types; and a microcomputer transferring the display device type identifying data read from the data storage to the setup control part and controlling the display condition of the images, wherein the setup control part identifies the type of the display device based on the display-identifying data received from the microcomputer and provides a user interface corresponding to the identified type fo the display device among the plurality of user interfaces.

### CROSS-REFERENCE TO RELATED APPLICATIONS

This application claims the benefit of Korean Patent Application No. 2003-59914, filed Aug. 28, 2003, in the Korean Intellectual Property Office, the disclosure of which is incorporated herein by reference.

### BACKGROUND OF THE INVENTION

1. Field of the Invention

The present invention relates to a display device, a display system and a storage medium, more particularly, a display device having a display system and a storage medium that provides a computer with a setup controller providing a user interface to adjust a condition of images displayed on the display device, and automatically specifying types of the display device connected to the computer and thus providing a sufficient user interface corresponding to the specified type of display device.

2. Description of the Related Art

A display device, such as a monitor, receives image signals from a graphic controller of a computer and displays images. The image signals are H/V (Horizontal/Vertical) sync signal, RGB (Red, Green, Blue) signal, and the like.

In general, a CDT (Color Display Tube) or an LCD (Liquid Crystal Display) is used as a display device for a monitor. The CDT for a CRT (Cathode Ray Tube) monitor is one of the electron tubes focusing and accelerating electrons from a negative electrode provided, sealed in the tube to generate electron beams, and controlling a direction of the electron beams using an electromagnetic field activity. The LCD displays images using contrast generated by injecting liquid crystal between two substrates and rearranging molecular structure of the injected liquid crystal using a voltage difference between electrodes of the two substrates.

A conventional display device 120, as shown in FIGS. 1 and 2, comprises an interface part 121 receiving an image signal; an image display part 122 displaying images; a signal processing part 123 where the image signal received through the interface part 121 converts into a displayable signal for the image display part 122; an OSD (On Screen Display) generator 125 generating an OSD signal; an OSD controller 126 generating a key signal; and a micro computer controlling the foregoing components. Herein, the OSD controller 126 comprises an OSD control button part 126b provided in front of the display device 120; and a key signal generator 126a generating key signals corresponding to a key operation through the OSD control button part 126b. Accordingly, the key signal generator 126a applies key signals to the microcomputer 124 corresponding to keys pressed through the OSD control button part 126b if a user presses the keys on OSD control button part 126b, and the microcomputer 124 controls the OSD generator 125 according to the key signals applied by the key signal generator 126a so as to display an OSD menu 140 in the image display part 122. Thus, display conditions such as brightness, contrast, and the size of the image can be controlled.

However, the conventional display device 120 has at least the following problems in a controlling manner of the display condition for images.

The conventional display device 120 requires additional components, such as the OSD generator 125 and the OSD control part 126, to control the display condition of images.

The conventional display device 120 includes data storage, such as an EEPROM (Electrical Erasable Programmable Read Only Memory) in which data and programs for the OSD menu 140 are stored. Such data storage imposes a limit on capacity, consequently causing a limit on capacity of the data and the programs for the OSD menu 140. The limited capacity causes the OSD menu 140 to be more simple than it should be. The user is presented with the OSD menu 140 providing inefficient information to control the display condition of images. Therefore, the conventional display device 120 has to provide a separate manual for instructions of the OSD menu 140 and controlling the display condition of images through the OSD menu 140, and the user has to refer to the manual to control the display condition of the display device 120.

The OSD control button part 126b only provides a limited number of control buttons because the OSD control button part is located in a front side of the display device 120. Accordingly, the user is required to press the control buttons several times to control the display condition of the display device 120, which in inconvenient.

Therefore, by overcoming the aforementioned problems, the display device can provide an improved user interface for controlling the display conditions of images.

### SUMMARY OF THE INVENTION

Accordingly, it is an aspect of the invention to provide a display device, a display system, and a storage medium that provide a convenient user interface for a user to control display conditions of images.

The user interface, which the display device, the display system and the data storage provide, can automatically identify types of the display device. Therefore, the user is presented with the user interface corresponding to the identified type of the display device.

The foregoing and/or other aspects of the invention are achieved by providing a method of controlling a display condition of images displayed in a display device connected to an external device, including transmitting display-identifying data from the display device to the external device; and displaying a user interface transmitted from the external device corresponding to the display-identifying data.

According to an aspect of the invention, a display condition of an image is controlled based on a control command transmitted from an external device.

According to an aspect of the invention, display-identifying data includes information about a type of a display device.

According to an aspect of the invention, display-identifying data further includes extended display identification data stored in a display device.

According to an aspect of the invention, extended display identification data further includes information about a vertical frequency and a range limit to identify a type of display device.

According to an aspect of the invention, a display device and an external device are connected to each other through a display data channel communication link to transmit extended display identification data and a control command to each other.

According to an aspect of the invention, a user interface comprises a user interface for a liquid crystal display type display device and a user interface for a cathode ray tube type display device.

According to another aspect of the invention, there is provided a method of controlling a display condition of images displayed in a display device of a display system connected to an external device, the method includes transmitting display-identifying data from the display device to the external device; identifying the display device connected to the external device from one of display devices based on the display-identifying data; selectively displaying a user interface for the identified type of display device; and controlling the display condition of images based on control commands transmitted from the external device.

According to an aspect of the invention, identifying a display device connected to an external device includes calculating a vertical frequency of the display device based on display-identifying data stored in a display device; and identifying the display device based on the calculated vertical frequency.

According to an aspect of the invention, a display device is identified as a liquid crystal display-type device when a value of the calculated vertical frequency is approximately 60 Hz based on display-identifying data stored in memory addresses 36 through 47 of the display device, wherein Video Electronics Standard Association regulates the memory addresses.

According to an aspect of the invention, a display device is identified as a cathode ray tube-type device when a value of the calculated vertical frequency is above 75 Hz based on display-identifying data stored in memory addresses 36 through 47 of the display device, wherein Video Electronics Standard Association regulates the memory addresses.

According to an aspect of the invention, identifying a display device connected to an external device includes identifying display-identifying data stored in memory addresses 71 and 72 of the display device, wherein Video Electronics Standard Association regulates the memory addresses.

According to an aspect of the invention, a display device is identified as a liquid crystal display-type device when a value of a highest vertical range limit stored in the display device is below 85 Hz.

According to an aspect of the invention, a display device is identified as a cathode ray tube-type when a value of a highest vertical range limit stored in the display device is above 86 Hz.

According to another aspect of the invention, a display device connected to an external device is identified by identifying display-identifying data stored in memory addresses 5Ah through 6Bh of the display device, wherein designations of the display devices are stored in a text format; and sorting data stored in the memory addresses to locate a display device-type indicator in text-formatted data, wherein Video Electronics Standard Association regulates the memory addresses.

According to an aspect of the invention, a display device is identified as a liquid crystal display-type device when a value of the calculated vertical frequency is approximately 60 Hz based on the display-identifying data stored in memory addresses 36 through 47 of the display device, wherein Video Electronics Standard Association regulates the memory addresses.

According to an aspect of the invention, a display device is identified as a liquid crystal display-type device when a value of a highest vertical range limit stored in the display device is below 85 Hz.

According to an aspect of the invention, a display device is identified as a cathode ray tube-type when a value of a highest vertical range limit stored in the display device is above 86 Hz.

According to an aspect of the invention, a display device and an external device are connected to each other through a display data channel communication link to transmit extended display identification data and a control command to each other.

According to an aspect of the invention, display-identifying data is transmitted from a display device to an external device and includes extended display identification data.

According to an aspect of the invention, a display device includes any of a liquid crystal display device, a cathode ray tube display device, a plasma display panel-type display device, and an organic electro luminescence-type display device.

According to an aspect of the invention, a separate user interface is provided for each display device having different dependent setup attributes.

According to an aspect of the invention, a plurality of methods of identifying a display device connected to an external device based on display-identifying data can be used simultaneously.

According to another aspect of the invention, a display device receives image signals from an external device and displays images, the display device includes a data storage to store display-identifying data including information about a type of the display device; and a microcomputer to transfer the display-identifying data to the external device, and control for displaying a user interface transmitted from the external device corresponding to the display-identifying data.

According to an aspect of the invention, a microcomputer controls a display condition of images based on a control command transmitted from an external device.

According to an aspect of the invention, display-identifying data includes information about a type of display device.

According to an aspect of the invention, display-identifying data includes extended display identification data stored in a display device.

According to an aspect of the invention, extended display identification data includes information about a vertical frequency and a range limit for identifying a type of display device.

According to an aspect of the invention, a display device system includes a user interface for a liquid crystal display type display device and a user interface for a cathode ray tube type display device.

According to an aspect of the invention, a display device and an external device are connected to each other through a display data channel communication link to transmit extended display identification data and a control command to each other.

According to another aspect of the invention, there is provided a display device that includes an external device to output image signals; and a display device to display the image signals as images, wherein the display device transmits a display-identifying data to the external device, the external device comprises a setup control part to identify the display device based on the display-identifying data and transmit an interface corresponding to the identified display device, and to display the user interface transmitted from the external device.

According to an aspect of the invention, a display device includes a setup control part that generates a control command corresponding to an operation of a user interface and the display device further includes a microcomputer to control a display condition of the images based on the control command transmitted from the setup control part.

According to an aspect of the invention, a display device includes a setup control part that includes a display condition setup program having a plurality of user interfaces corresponding to a type of a plurality of display devices to control the display condition of the images.

According to an aspect of the invention, a display device includes any one of a liquid crystal data-type display device, a cathode ray tube-type display device, a plasma display panel-type display device, and an organic electro luminescence-type display device.

According to an aspect of the invention, display-identifying data that is transmitted to an external device is extended display identification data.

According to an aspect of the invention, a display device and an external device are connected to each other through a display data channel communication link to transmit extended display identification data and the control command to each other. According to an aspect of the invention, the external device is a computer.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of the embodiments, taken in conjunction with the accompany drawings in which:

FIG. 1 is a control block diagram of a conventional display device;

FIG. 2 is a front view of the conventional display device having an on-screen display message displayed thereon;

FIG. 3 is a control block diagram of a display device in a display system according to an embodiment of the invention;

FIGS. 4 through 6 are sample tables of extended display identification data containing display type identifying information; and

FIG. 7 is a flowchart of the display system according to the embodiment of the invention.

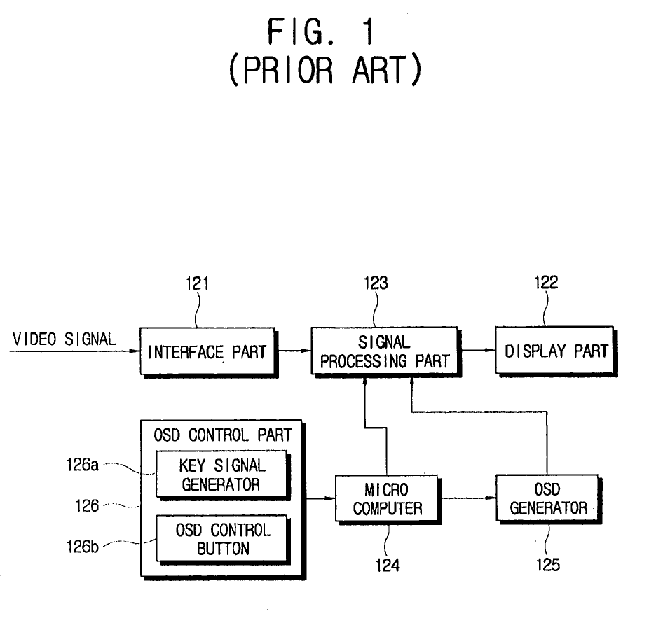

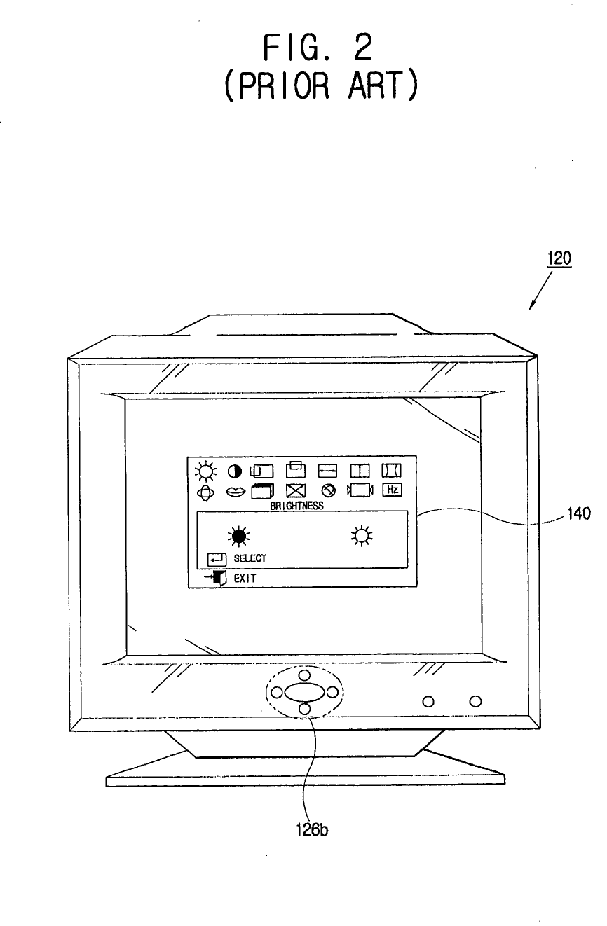

### DETAILED DESCRIPTION OF THE PREFERRED EMBODIMENTS

Reference will now be made in detail to the embodiments of the invention, examples of which are illustrated in the accompanying drawings, wherein like reference numerals refer to like elements throughout. The embodiments are described below in order to explain the present invention by referring to the figures.

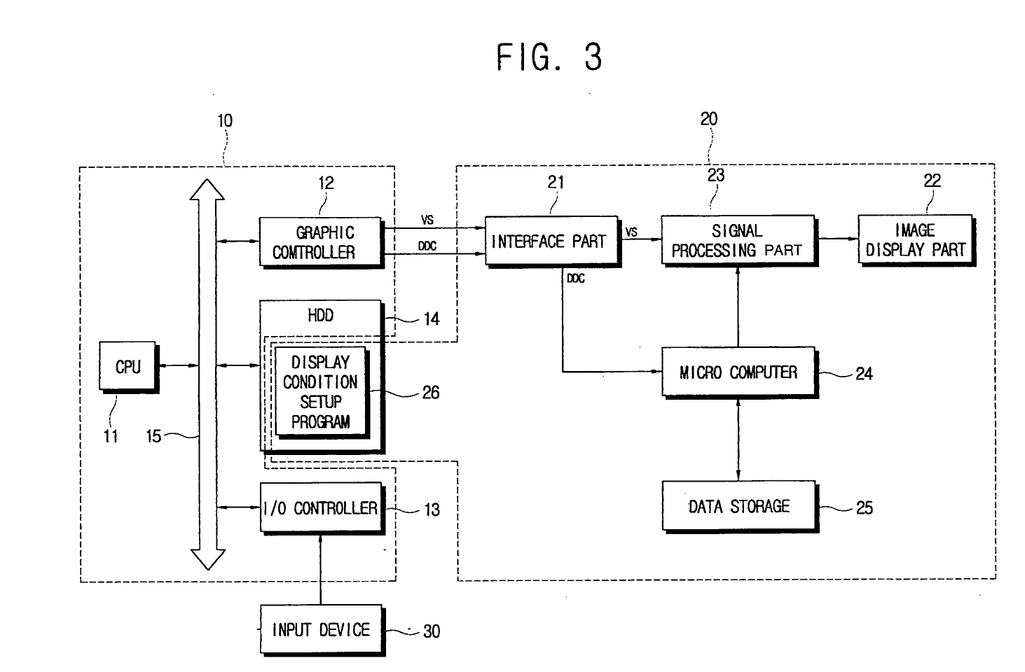

A display system according to an aspect of the invention, as shown in FIG. 3, comprises an image signal source outputting an image signal, and a display device 20 receiving the image signal from the image signal source and displaying it as an image. Here, a computer 10 is exemplified as the image signal source; however, the invention is not limited to using only the computer as the image signal source. Any device connected with the display device and connected with a user interface interactively communicating with the image signal and the display device can be included as the image signal source.

The computer 10 comprises a CPU (Central Processing Unit), a graphic controller 12 outputting the image signal to the display device 20, an I/O (Input/Output) controller 13 connected with input devices 30 (a keyboard, a mouse, etc.) and processing signals inputted through the input devices 30, a HDD (Hard Disk Drive) 14 storing an OS (Operating System) or a plurality of OS-based applications, and a system bus interconnecting the foregoing components.

The display device 20 comprises an interface part 21 connected to the graphic controller 12 and receiving the image signals; a display part 22 displaying images; a signal processing part 23 converting the image signal from the interface part 21 into a displayable signal for the display part 22; and a microcomputer 24 controlling the foregoing.

The interface part 21 receives the image signal outputted from the graphic controller 12. The image signal from the graphic controller 12 includes RGB (Red/Green/Blue) signal and H/V (Horizontal/Vertical) Sync signal. Herein, various devices that are connectable to the graphic controller 12 of the computer 10 can be provided in the interface part 21, including a D-Sub connector, a DVI (Digital Visual Interface) terminal, and the like.

The interface part 21 also provides an interface interactively communicating with the computer 10. Accordingly, the computer 10 can transmit data other than the image signals to the display device 20, and the display device 20 can transmit data saved in the display device 20 to the computer 10. For example, the interface part 21 may support a DDC (Display Data Channel) function that interactively communicates with the computer 10. Other interfaces, such as a USB (Universal Serial Bus) interface, are available for interactively transmitting data.

The DDC function implements what is commonly referred to as a “Plug-and-Play” function, which automatically sets a system environment for the display system. The VESA (Video Electronics Standard Association) standardized the DDC function and regulates a signal link and a process when a computer 10 and a display device 20 exchange data.

The display part 22 and the signal processing part 23 of the display device 20 can be variously composed depending on types of the display device 20. If the display device 20 is an LCD (Liquid Crystal Display) type, the signal processing part 23 may include an A/D (Alternative/Direct) converter converting the H/V sync signal and the RGB image signal inputted through the interface part 21 into a digital image signal, and a scaler scaling the digital image signal outputted from the A/D converter. is the LCD type.

If the display device 20 is a CRT (Cathode Ray Tube)-type, the signal processing part 23 may include an amplifier, and the like, amplifying image signals inputted through the interface part 21, and an H/V deflection part deflecting electron beams based on the H/V sync signal. The display part 22 may include a negative electrode tube if the display device 20 is the CRT.

The microcomputer 24 of the display device 20 controls the signal processing part 23 and the display part 22 so that the display condition of images are controlled based on a plurality of predetermined setup attributes. Herein, the plurality of setup attributes provided to control the display condition of images are stored in the data storage 25 which is provided as a non-volatile memory such as an EEPROM (Electrical Erasable Programmable Read Only Memory).

The display device 20 includes a setup control part provided in the computer 10 and provides a user interface to set a display condition of images. The setup control part is exemplified as a display condition setup program 26 installed in the computer 10 for a display condition setup. The display condition setup program 26 is stored in the HDD 14 of the computer 10, installed in the computer 10, and operated based on an operating system. The display condition setup program 26 transmits control commands to control the display condition of images to the microcomputer 24 through the DDC communication link. The display condition setup program may also be stored in a computer-readable storage medium, such as a memory device, a compact disk, a digital video disk, etc.

The display condition setup program 26 provides a plurality of user interfaces to set the display condition of images corresponding to various types of display devices. If the display device 20 connected with the computer 10 is the CRT, the display condition setup program 26 provides a user interface for a CRT, or provides a user interface for a LCD if the display device 20 connected with the computer 10 is the LCD. The reason that the display condition setup program 26 provides a different user interface for a different type of display device is that a different type of display device has different setup attributes for controlling the display condition of images.

If the display device is LCD and CRT compatible, a resolution attribute only works for the LCD, while other attributes such as trapezoid, parallelogram, pin cushion, pin balance, rotation, degausing, and moire only work for the CRT.

Therefore, if the display device is the LCD, the display condition setup program 26 provides a user interface for the LCD so that display device type independent attributes (e.g. brightness, contrast, position, size, etc.) and display device type dependent attributes (e.g. resolution) can be controlled together. However, if the display device is the CRT, the display condition setup program 26 provides a user interface for the CRT so that the display device type independent attributes (e.g. brightness, contrast, position, size, etc.) and display device type dependent attributes (e.g. trapezoid, parallelogram, pin cushion, pin balance, rotation, degausing, and moiré) can be controlled together.

The conventional display device 20 can overcome the limit on storage capacity by having the display condition setup program 26 installed in the computer 10, thus providing more convenient and various information through the user interface provided by the display condition setup program 26 to control display conditions for images. Further, the display condition setup program 26 can handle different types of the display device 20 even if the type of display device 20 connected to the computer 10 is changed, because the display condition setup program 26 offers a user interface corresponding to different types of display devices.

On the other hand, the display condition setup program 26 determines the type of display device based on display identifying data stored in the data storage 25. The display identifying data contains information about the types of the display device, and EDID (Extended Display Identification) data is used as the display identifying data. The microcomputer 24 reads the EDID data from the data storage 25 when the display device 20 is connected to the computer 10 and transmits the read EDID data to the computer 10 through the DDC communication link of the interface part 21. Concurrently, the display condition setup program 26 identifies the type of the display device 20 based on the EDID data transmitted to the computer 10 through the DCC communication link and provides a user interface corresponding to the identified type of display device 20. Thus, the user interface provided for the display device is automatically identified by the display condition setup program 26 without involving a user in this identification.

Further, if the user operates the user interface through the input device 30, the display condition setup program 26 transmits a control command corresponding to the user's operation to the microcomputer 24 through the DCC communication link. At this time, the microcomputer 24 controls the signal processing part 23 and the display part 22 to convert the display condition of images based on the control commands received through the DCC communication link. Controlling display conditions of images is more convenient by having the input device 30, such as a mouse, control the display condition of images.

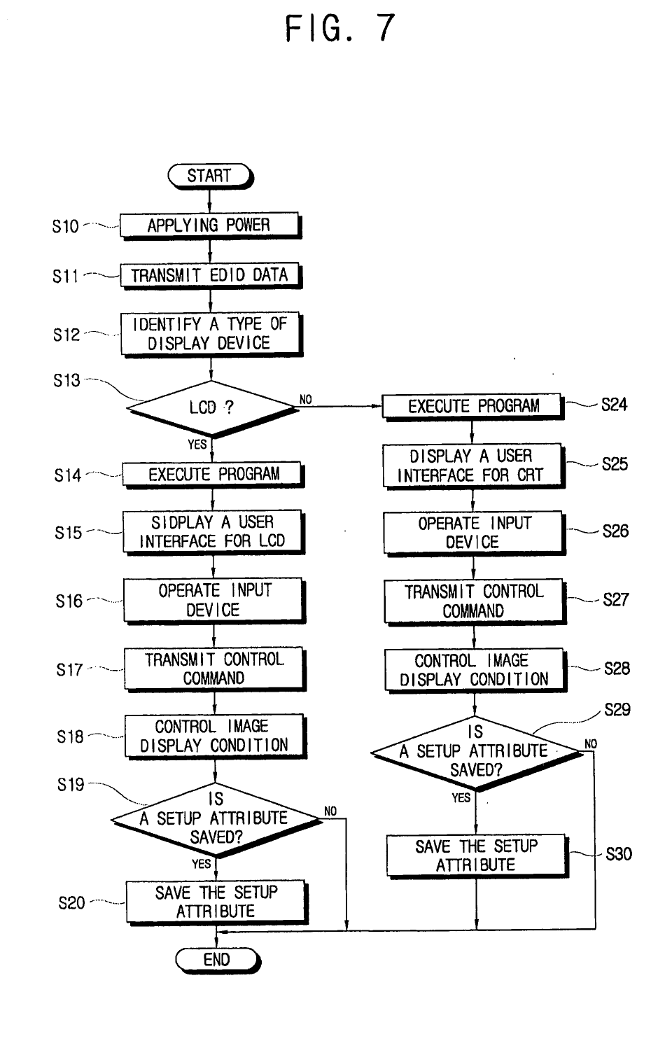

Referring to FIG. 7, a control process for a display condition of images displayed in the display device 20 of the display system according to the above configuration is described hereinbelow.

In operation S10, power is applied to the display system having the computer 10 and the display device 20 connected together. In operation S11, the microcomputer 24 reads the EDID data from the data storage 25 and transmits the read EDID data to the computer 10 through the DDC communication link.

The computer 10 receives the EDID data through the DDC communication link and then performs the plug-and play function. In addition, in operation S12, the display condition setup program 26 identifies the type of the display device based on the read EDID data received through the DDC communication link.

Herein, based on the read EDID data, the display condition setup program 26 identifies the type of the display device in the following manner.

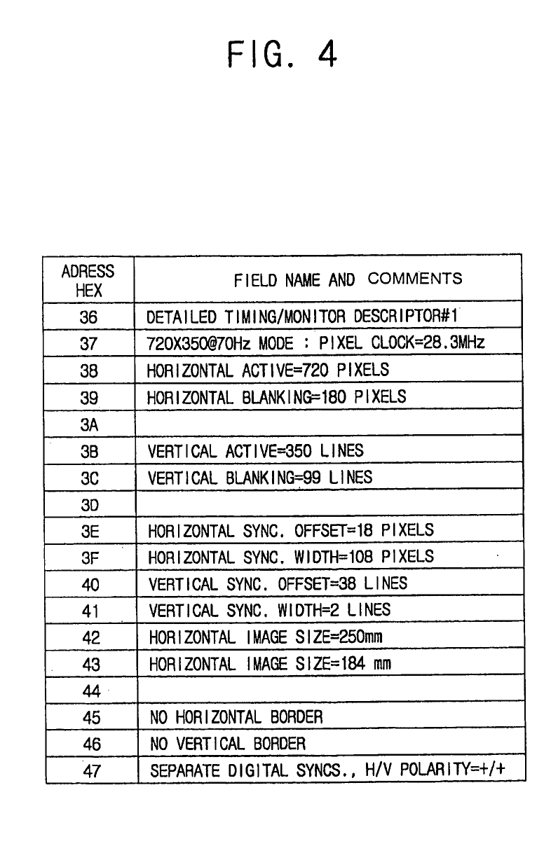

The display condition setup program 26 calculates a vertical frequency of the display device connected to the computer 10 based on the EDID data stored at memory addresses 36 through 47, as shown in FIG. 4, and these memory addresses are regulated by the VESA. The display condition setup program 26 then identifies the type of the display device based on the calculated vertical frequency. For example, the display condition setup program 26 regards the display device 20 as an LCD type display device if a value of the calculated vertical frequency is approximately 60 Hz, or a CRT type display device if a value of the calculated vertical frequency is above 75 Hz.

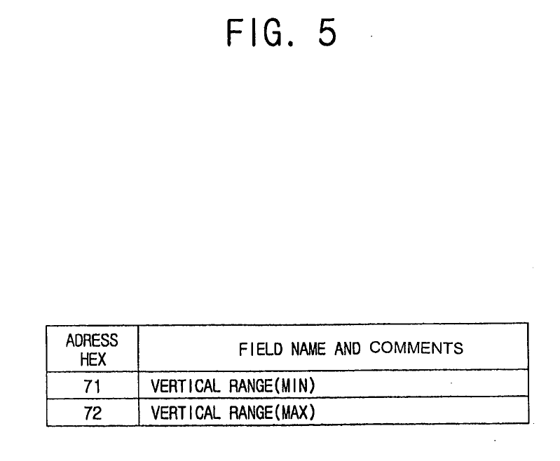

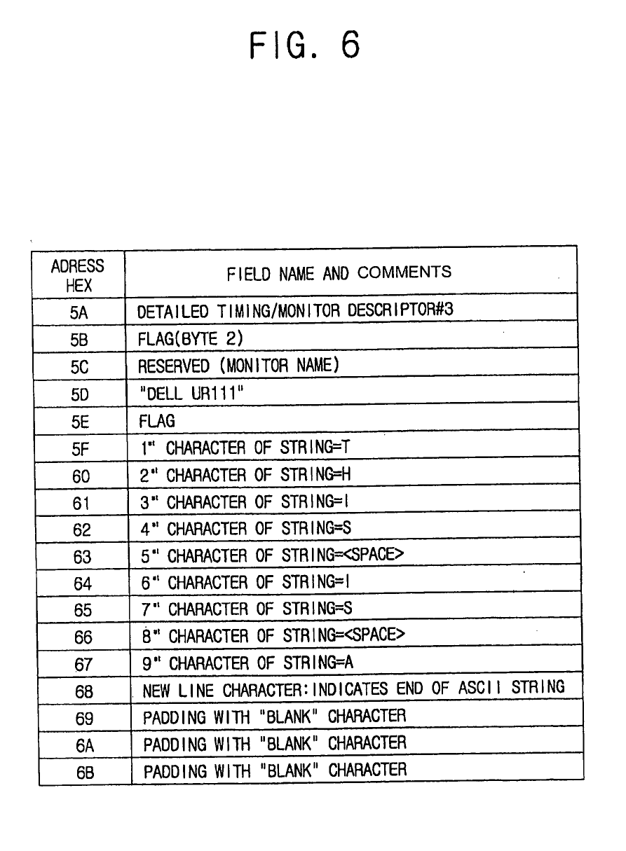

The display condition setup program 26 identifies the type of the display device connected to the computer 10 based on the EDID data stored at memory addresses 71 through 72, as shown in FIG. 5, and these memory addresses are regulated by the VESA. For example, the display condition setup program 26 regards the display device 20 as an LCD type display device if a value of the highest vertical range limit stored at the memory address 72 is below 85 Hz, or a CRT type display device if the value of the highest vertical range limit stored at the memory address 72 is above 86 Hz.

The display condition setup program 26 identifies the type of the display device connected to the computer 10 based on the EDID data stored at memory addresses 5Ah through 6Bh, as shown in FIG. 7, and these memory addresses are regulated by the VESA. In the memory addresses 5Ah through 6Bh, the display device relates information such as a serial number, information of a manufacturer, and an appellation of the display device 20 are stored in a text format, and thus the display condition setup program 26 sorts the data stored in the addresses 5Ah through 6Bh to find a display device type indicator (e.g. “LCD”, “CRT”, or “CDT”) in the text-formatted data so as to identify the type of the display device 20.

In this manner, the display condition setup program 26 identifies whether the type of the display device 20 connected to the computer 10 is an LCD type display device or a CRT type display device in operation S12, and selectively displays a user interface either for the LCD or the CRT at operation S15 or S25 as a user runs the display condition setup program 26 at operation S14 or S24.

If, the user operates the input device 30, such as a mouse, to control the display condition of image through the user interface displayed on the display device 20 in operation S16 or S26, the display condition setup program 26 transmits the control command corresponding to the user's operation performed through the user interface to the microcomputer 24 through the DCC communication link, in operation S17 or S27.

The microcomputer 24 then controls the display part 22 and the signal processing part 23 to control the display condition of images based on the control commands transmitted from the display condition setup program 26, in operation S18 or S28. Concurrently, if the user changes setup attributes for a display condition and selects saving the changed setup attributes in operation S19 or S29, the display condition setup program 26 applies the corresponding control command to the microcomputer 24 through the DDC communication link and then the microcomputer 24 saves the changed setup attributes to the data storage 25 in operation S20 or S30.

In the foregoing aspect of the invention, the LCD-type display device and the CRT-type display device are shown as the type of the display device 20; however, other display devices may be used as the display device 20, such as a Plasma Display Panel (PDP)-type display device and an Organic Electro Luminescence type display device. Herein, if a display device dependent setup attribute exists, or a setup attribute exists that only the LCD type display device or the CRT type display device supports and the Plasma Display Panel type display device or the Organic Electro Luminescence type display device does not support, the display condition setup program 26 provides a separate user interface for each type of the display devices 20.

In addition, the foregoing aspects also described three methods of identifying the type of the display device 20 based on the EDID data, wherein only one of the three methods can be used to identify the type of the display devices, but two or all of the methods also can be involved at the same time. According to the above aspect, a setup control part is an element of the display device, but it may also be an element of an external device, such as a computer.

The display device, the display system, and the storage medium according to the aspect of the invention provides a user interface comprising the display condition setup program 26 that is provided in the computer 10 and offers a plurality of user interfaces to set sufficient display conditions of images corresponding to a plurality of display devices 20 and generates the control command through the user interface operation performed by a user. The micro computer 24 transmits the data identifying the type of the display device read from the data storage 25 to a setup control part and controls the display condition of images based on the control command received through the setup control part. The setup control part identifies the type of the display device based on the display device identifying data received from the micro computer 24 received and provides a user interface for the corresponding type of the display device among the plurality of user interfaces. In addition, the display condition setup program 26 automatically identifies the type of the display device 20, thus providing a user interface corresponding to the identified type of the display device.

Although a few embodiments of the present invention have been shown and described, it will be appreciated by those skilled in the art that changes may be made in these embodiments without departing from the principles and spirit of the invention, the scope of which is defined in the claims and their equivalents.

1. A method of controlling a display condition of images displayed in a display device connected to an external device, the method comprising:
transmitting display-identifying data from the display device to the external device; and
displaying a user interface transmitted from the external device corresponding to the display-identifying data.

2. The method of claim 1, further comprising controlling the display condition of the images based on a control command transmitted from the external device.

3. The method of claim 2, wherein the display-identifying data comprises information about a type of the display device.

4. The method of claim 3, wherein the display-identifying data further comprises extended display identification data stored in the display device.

5. The method of claim 4, wherein the extended display identification data further comprises information about a vertical frequency and a range limit to identify the type of the display device.

6. The method of claim 4, wherein the display device and the external device are connected to each other through a display data channel communication link to transmit the extended display identification data and the control command to each other.

7. The method of claim 1, wherein the user interface comprises a user interface for a liquid crystal display type display device and a user interface for a cathode ray tube type display device.

8. A method of controlling a display condition of images displayed in a display device of a display system connected to an external device, the method comprising:
transmitting display-identifying data from the display device to the external device;
identifying the display device connected to the external device from one of display devices based on the display-identifying data;
selectively displaying a user interface for the identified type of display device; and
controlling the display condition of images based on control commands transmitted from the external device.

9. The method of claim 8, wherein the identifying the display device connected to the external device further comprises:
calculating a vertical frequency of the display device based on the display-identifying data stored in the display device; and
identifying the display device based on the calculated vertical frequency.

10. The method of claim 9, further comprising identifying the display device as a liquid crystal display-type device when a value of the calculated vertical frequency is approximately 60 Hz based on the display-identifying data stored in memory addresses 36 through 47 of the display device, wherein Video Electronics Standard Association regulates the memory addresses.

11. The method of claim 9, further comprising identifying the display device as a cathode ray tube-type device when a value of the calculated vertical frequency is above 75 Hz based on the display-identifying data stored in memory addresses 36 through 47 of the display device, wherein Video Electronics Standard Association regulates the memory addresses.

12. The method of claim 8, wherein the identifying the display device connected to the external device comprises identifying the display-identifying data stored in memory addresses 71 and 72 of the display device, wherein Video Electronics Standard Association regulates the memory addresses.

13. The method of claim 12, further comprising identifying the display device as a liquid crystal display-type device when a value of a highest vertical range limit stored in the display device is below 85 Hz.

14. The method of claim 12, further comprising identifying the display device as a cathode ray tube-type when a value of a highest vertical range limit stored in the display device is above 86 Hz.

15. The method of claim 12, wherein the identifying the display device connected to the external device further comprises:
identifying the display-identifying data stored in memory addresses 5Ah through 6Bh of the display device, wherein designations of the display devices are stored in a text format; and
sorting data stored in the memory addresses to locate a display device-type indicator in text-formatted data, wherein Video Electronics Standard Association regulates the memory addresses.

16. The method of claim 8, wherein at least two methods of identifying the display device connected to the external device is involved in identifying the display device, the methods of identifying the display device comprising:
calculating a vertical frequency of the display device based on the display-identifying data stored in the display device and identifying the display device based on the calculated vertical frequency;
identifying the display-identifying data stored in memory addresses 71 and 72 of the display device; and
identifying the display-identifying data stored in memory addresses 5Ah through 6Bh of the display device, wherein designations of the display devices are stored in a text format, and sorting data stored in the memory addresses to locate a display device-type indicator in text-formatted data, wherein Video Electronics Standard Association regulates the memory addresses.

17. The method of claim 16, further comprising identifying the display device as a liquid crystal display-type device when a value of the calculated vertical frequency is approximately 60 Hz based on the display-identifying data stored in memory addresses 36 through 47 of the display device, wherein Video Electronics Standard Association regulates the memory addresses.

18. The method of claim 16, further comprising identifying the display device as a cathode ray tube-type device when a value of the calculated vertical frequency is above 75 Hz based on the display-identifying data stored in memory addresses 36 through 47 of the display device, wherein Video Electronics Standard Association regulates the memory addresses.

19. The method of claim 16, further comprising identifying the display device as a liquid crystal display-type device when a value of a highest vertical range limit stored in the display device is below 85 Hz.

20 The method of claim 16, further comprising identifying the display device as a cathode ray tube-type when a value of a highest vertical range limit stored in the display device is above 86 Hz.

21. The method of claim 8, wherein the display device and the external device are connected to each other through a display data channel communication link to transmit the extended display identification data and the control command to each other.

22. The method of claim 8, wherein the display-identifying data transmitted from the display device to the external device comprises extended display identification data.

23. The method of claim 8, wherein the plurality of display devices comprises a liquid crystal display device, a cathode ray tube display device, a plasma display panel-type display device, and an organic electro luminescence-type display device.

24. The method of claim 8, wherein a separate user interface is provided for each of the plurality of display devices having different dependent setup attributes.

25. The method of claim 8, wherein a plurality of methods of identifying the display device connected to the external device based on the display-identifying data can be used simultaneously.

26. A display device receiving image signals from an external device and displaying images, the display device comprising:
a data storage to store display-identifying data including information about a type of the display device; and
a microcomputer to transfer the display-identifying data to the external device, and control for displaying a user interface transmitted from the external device corresponding to the display-identifying data.

27. The display device of claim 26, wherein the microcomputer controls a display condition of the images based on a control command transmitted from the external device.

28. The display device of claim 27, wherein the display-identifying data comprise information about the type of the display device.

29. The display device of claim 28, wherein the display-identifying data comprises extended display identification data stored in the display device.

30. The display of claim 29, wherein the extended display identification data comprises information about a vertical frequency and a range limit for identifying the type of the display device.

31. The display device of claim 30, wherein the user interface includes a user interface for a liquid crystal display type display device and a user interface for a cathode ray tube type display device.

32. The display device of claim 29, wherein the display device and the external device are connected to each other through a display data channel communication link to transmit the extended display identification data and the control command to each other.

33. A display system comprising:
an external device to output image signals; and
a display device to display the image signals as images, wherein the display device transmits a display-identifying data to the external device, the external device comprises a setup control part to identify the display device based on the display-identifying data and transmit an interface corresponding to the identified display device, and to display the user interface transmitted from the external device.

34. The display system of claim 33, wherein the setup control part generates a control command corresponding to an operation of the user interface and the display device comprises a microcomputer controlling a display condition of the images based on the control command transmitted from the setup control part.

35. The display system of claim 34, wherein the setup control part comprises a display condition setup program having a plurality of user interfaces corresponding to a type of a plurality of display devices to control the display condition of the images.

36. The display system of claim 35, wherein the type of the display device comprises any one of a liquid crystal data-type display device, a cathode ray tube-type display device, a plasma display panel-type display device, or an organic electro luminescence-type display device.

37. The display system of claim 33, wherein the display-identifying data transmitted to the external device is extended display identification data.

38. The display system of claim 37, wherein the display device and the external device are connected to each other through a display data channel communication link to transmit the extended display identification data and the control command to each other.

39. The display system of claim 33, wherein the external device is a computer.
